(19) United States
(12) Patent Application Publication
(10) Pub. No.: US 2025/0093013 A1
(43) Pub. Date: Mar. 20, 2025

(54) LIGHTING DEVICE

(71) Applicant: Panasonic Intellectual Property Management Co., Ltd., Osaka (JP)

(72) Inventor: KENICHIRO MASE, Osaka (JP)

(21) Appl. No.: 18/961,663

(22) Filed: Nov. 27, 2024

Related U.S. Application Data
(63) Continuation of application No. PCT/JP2023/019214, filed on May 23, 2023.

(30) Foreign Application Priority Data
Jun. 9, 2022 (JP) 2022-093507

(51) Int. Cl. F21V 5/00; F21V 11/14

(52) U.S. Cl. CPC F21V 5/007; F21V 11/14

(57) ABSTRACT

A lighting device that emits light to a lighting target surface and includes a light source, and a lens having an incident surface that receives light emitted from the light source and an emission surface that emits the light received by the incident surface. The emission surface is a convex curved surface. The curvature of the emission surface along a first direction perpendicular to an optical axis direction of the lens is smaller than the curvature of the emission surface along a second direction perpendicular to the optical axis direction and the first direction.

### TECHNICAL FIELD

The present disclosure relates to a lighting device.

### BACKGROUND ART

There has conventionally known a lighting device for a lighting setup called a horizontal light that lights a background wall of a studio of a television company, a stage, or the like.

For example, the lighting device of PTL 1 includes a first light source and a second light source. The light of the second light source is emitted above the background wall and has a flat light distribution characteristic. A plurality of prisms are provided on a reflection surface of a light guide plate. The light of the first light source is emitted lower than the light of the second light source on the background wall (lighted surface) and forms a region having a light distribution characteristic with higher illuminance than the surroundings (that is, stray light). As a result, the lighting device of PTL 1 forms a light pool on the lower portion of the background wall, and has a stretched light distribution characteristic in which illuminance gradually decreases toward the upper portion of the background wall.

### CITATION LIST

### Patent Literature

PTL 1: Unexamined Japanese Patent Publication No. 2014-127380

### SUMMARY OF THE INVENTION

In recent years, a need for enhancing color rendering properties by a lighting device has been increasing. Not only for a wide space like a stage, there is a demand for a lighting device with such a high quality as can be used for a lighting setup in a narrow space such as a corridor or a limited small space such as in a train, a car, and an airplane. Thus, a lighting device that is made small in size and capable to be disposed near a lighting target surface is needed.

An object of the present disclosure is to provide a lighting device that can be made small in size and ensure lighting quality even when the lighting device is disposed near a lighting target surface.

To achieve the above object, a lighting device according to one exemplary embodiment of the present disclosure is a lighting device that emits light to a lighting target surface and includes a light source, and a lens having an incident surface that receives light emitted from the light source and an emission surface that emits light received by the incident surface. The emission surface is a convex curved surface. The curvature of the emission surface along a first direction perpendicular to an optical axis direction of the lens is smaller than the curvature of the emission surface along a second direction perpendicular to the optical axis direction and the first direction.

According to the present disclosure, the lighting device can be downsized, and lighting quality can be ensured even when the lighting device is disposed near a lighting target surface.

### BRIEF DESCRIPTION OF THE DRAWINGS

FIG. 1 is a configuration diagram of a lighting device according to a first exemplary embodiment.

FIG. 2 is a configuration diagram of a lens according to the first exemplary embodiment.

FIG. 3 is a view illustrating an arrangement example of the lighting device according to the first exemplary embodiment.

FIG. 4A is a view for explaining a lighting device according to a second exemplary embodiment.

FIG. 4B is a view for explaining the lighting device according to the second exemplary embodiment.

FIG. 5A is a view for explaining a lighting device according to a third exemplary embodiment.

FIG. 5B is a view for explaining the lighting device according to the third exemplary embodiment.

FIG. 6 is a view for explaining a lighting device according to a fourth exemplary embodiment.

FIG. 7 is a view for explaining a lighting device according to a fifth exemplary embodiment.

FIG. 8 is a view for explaining a lighting device according to a sixth exemplary embodiment.

FIG. 9 is a configuration diagram of a lighting device according to a seventh exemplary embodiment.

FIG. 10 is a configuration diagram of a lighting device according to an eighth exemplary embodiment.

### DESCRIPTION OF EMBODIMENT

Hereinafter, exemplary embodiments of the present invention will be described in detail with reference to the drawings. The following description of preferred exemplary embodiments is merely exemplary in nature and is not intended to limit the present invention, its applications, or its usages. In the following description, the same parts are denoted by the same reference mark, and detailed description thereof will be omitted as appropriate.

### First Exemplary Embodiment

### (Configuration of Lighting Device)

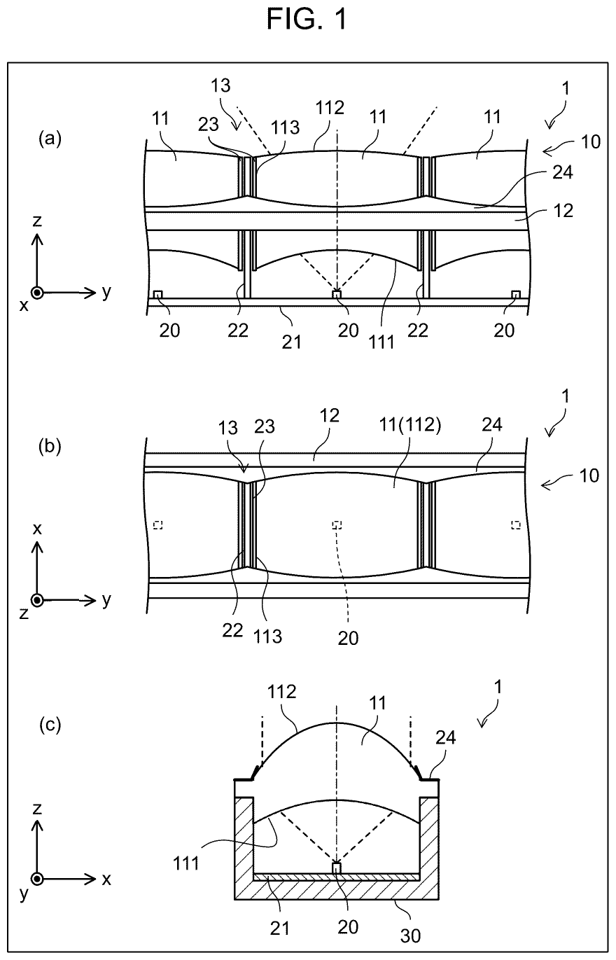

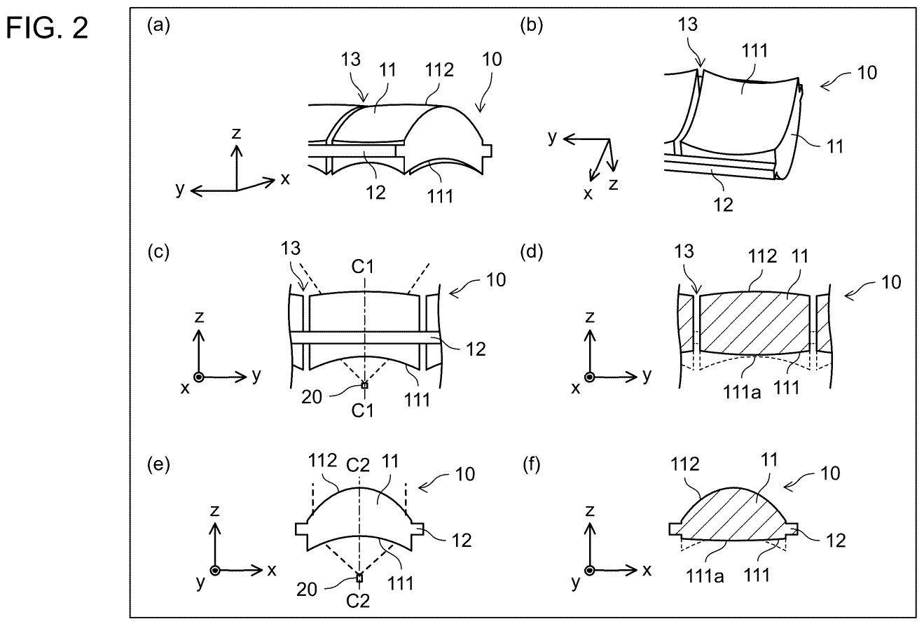

FIG. 1 is a configuration diagram of a lighting device according to a first exemplary embodiment, and FIG. 2 is a configuration diagram of a lens according to the first exemplary embodiment. Specifically, part (a) of FIG. 1 is a front view of lighting device 1, part (b) of FIG. 1 is a top view of lighting device 1, and part (c) of FIG. 1 is a side cross-sectional view of lighting device 1. Part (a) of FIG. 2 is a perspective view of lens 11 as viewed from above, part (b) of FIG. 2 is a perspective view of lens 11 as viewed from below, part (c) of FIG. 2 is a front view of lens 11, part (d) of FIG. 2 is a front cross-sectional view of a side central portion of lens 11, part (e) of FIG. 2 is a side view of lens 11, and part (f) of FIG. 2 is a side cross-sectional view of a front central portion of lens 11. In the drawings including FIG. 1, description will be given under the definition that an optical axis direction of lens 11 is z direction (corresponding to the optical axis direction), an extending direction of lens connector 12 (the arrangement direction of lenses 11) is y direction (corresponding to a first direction), and a direction perpendicular to the y direction and the z direction is x direction (corresponding to a second direction). In the following description, the light emitted from LED light source 20 is indicated by broken lines in the drawings including FIG. 1.

As illustrated in FIGS. 1 and 2, lighting device 1 includes lens unit 10, LED light sources 20, and housing 30. Housing 30 accommodates LED light sources 20, and lens unit 10 is disposed at an opening of housing 30.

Lens unit 10 includes a plurality of lenses 11 and a pair of lens connectors 12.

Lens 11 is a lens formed in a substantially semi-cylindrical shape, and is formed of a transparent optical member such as optical glass or an optical resin material. A plurality of lenses 11 are arranged in the y direction, and are connected to each other by a pair of lens connectors 12 facing each other in the x direction. Slit 13 is formed between adjacent lenses 11. Lens unit 10 is formed by injection molding or the like. Lens connector 12 is a member formed of resin, for example.

Lens 11 has incident surface 111 and emission surface 112. Lens 11 receives light from LED light source 20 by incident surface 111 and emits light from emission surface 112.

Incident surface 111 is a concave curved surface having convex portion 111a at a central portion in an xy plane (see parts (c) to (f) of FIG. 2). That is, incident surface 111 has such a shape that the central portion is convex and the portion around the central portion is concave. This shape creates a light distribution with a reduced illuminance in the central portion and a smooth illuminance change in the peripheral portion. Thus, lens 11 creates a light distribution that gradually changes darker from the central portion to the outer edge.

Emission surface 112 is a curved surface having a prominent convex shape along the x direction and a gentle convex shape along the y direction (see parts (c) to (f) of FIG. 2). That is, emission surface 112 has a smaller convex curvature along the y direction than along the x direction. Emission surface 112 creates with this shape a light emitted from lens 11 not diffusing in the x direction and diffusing in the y direction.

LED light source 20 is a light source including an LED (Light Emitting Diode), for example. LED light source 20 is mounted on LED substrate 21, and when a current is applied emits light having a wavelength and intensity corresponding to the characteristics of LED light source 20. LED light source 20 can output a light of any color. LED light source 20 may be a single color light source or a light source of a plurality of colors. As illustrated in the drawings including FIG. 1, LED light source 20 emits a diffused light spreading in certain ranges in the x direction and the y direction.

As illustrated in parts (a) and (b) of FIGS. 1, a plurality of LED light sources 20 are arranged on LED substrate 21. In the present exemplary embodiment, one LED light source 20 is disposed to correspond to one of lenses 11.

Lenses 11 are arranged with a predetermined distance therebetween in the y direction. Thus, slit 13 is formed between lenses 11 adjacent in the y direction. Slit 13 formed between lenses 11 allows only the light emitted from the corresponding one of LED light sources 20 to enter lens 11 and disallows entering of the light emitted from LED light sources 20 corresponding to other lenses 11.

Light shielding plate 22 is disposed in slit 13. Light shielding plate 22 is formed of a black resin, a metal material, or the like, and is desirably formed of a mat-like material having a high diffusivity to discourage regular reflection on the surface of light shielding plate 22. For lens 11, light shielding plate 22 can prevent entering of the light emitted from LED light sources 20 corresponding to other lenses 11.

Absorption layer 23 is formed on side surface 113, facing the y direction, of lens 11. Absorption layer 23 is a black, sheet-like layer, and has an adhesive surface having a refractive index close to that of lens 11. Absorption layer 23 can prevent interface reflection that may occur at side surface 113 of lens 11.

On incident surface 111 of lens 11, stray light cover 24 is disposed to cover an outer rim in the x direction. Stray light cover 24 is formed of a black resin or a metal material, and is desirably formed of a mat-like material having a high diffusivity to discourage regular reflection on the surface. LED light source 20 emits a diffused light spreading radially in an arc shape in plan view. In contrast, emission surface 112 of lens 11 is rectangular in plan view. Thus, stray light may be created at a corner of emission surface 112 of lens 11. Covering corners (four corners) of emission surface 112 with stray light cover 24 can suppress occurrence of stray light. Note that, stray light may by suppressed without using stray light cover 24 by forming lens 11 (specifically, shaping emission surface 112, for example, of lens 11) in a circular shape in plan view. In this case, the connection area between lens connector 12 and lens 11 is reduced, and this means that the cross-sectional shape significantly changes locally from lens connector 12 to lens 11. This results in a low rigidity of lens unit 10. Therefore, stray light cover 24 is preferable used.

### (Arrangement of Lighting Device)

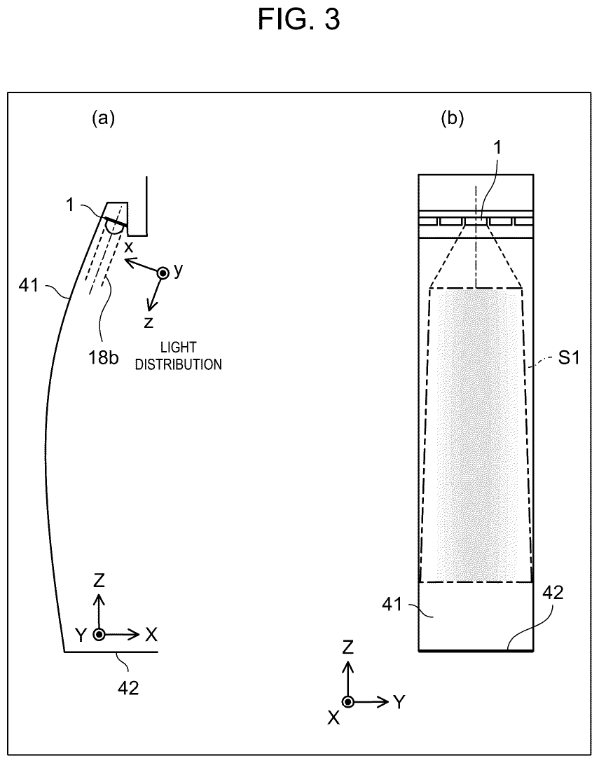

FIG. 3 is a view illustrating an arrangement example of the lighting device according to the first exemplary embodiment. Specifically, part (a) of FIG. 3 is a side view illustrating the light distribution of the lighting device, and part (b) of FIG. 3 is a front view illustrating the light distribution of lighting device 1. In the following description, XYZ coordinates different from the xyz coordinates in FIGS. 1 and 2 may be used. Specifically, Y direction is the same as the y direction, Z direction is the same as the up-down direction, and Y direction is a direction perpendicular to the X direction and the Z direction.

As illustrated in parts (a) and (b) of FIG. 3, lighting device 1 is disposed above lighting target surface 42 (floor surface 41) and emits light to lighting target surface 42 (wall surface). Specifically, lighting device 1 is disposed such that the light emission direction is inclined with respect to the up-down direction.

As described above, emission surface 112 of lens 11 is a curved surface having a prominent convex shape along the x direction and a gentle convex shape along the y direction. That is, lighting device 1 emits a light not diffusing in the X direction and diffusing in the Y direction. Therefore, lighting device 1 can create a light distribution wide in the X direction and the Y direction on lighting target surface 42. Therefore, by using lens 11 having emission surface 112 according to the present exemplary embodiment, lighting device 1 can be downsized, and lighting quality can be ensured even when lighting device 1 is disposed close to lighting target surface 42.

In addition, incident surface 111 of lens 11 is a concave curved surface having convex portion 111a at the central portion in an xy plane. That is, light distribution S1 of lighting device 1 has illuminance reduced in the central portion and smoothly changing toward the outer rim (see part (b) of FIG. 3). Therefore, lighting device 1 creates light distribution S1 that gradually changes darker from the central portion to the outer edge. A sharp decrease in illuminance to become darker at the outer edge in the light distribution of lighting device 1 is suppressed.

In a conventional lighting device, light distribution control is performed by a mirror or the like. Thus, there is a sharp decrease in illuminance to become darker at an end portion in the illuminance distribution, which makes it difficult to ensure lighting quality when the lighting device is disposed in a narrow space. Even when a lens (for example, a cylindrical lens) is used instead of a mirror, the outer edge sharply becoming darker in the light distribution cannot be avoided, and thus the lighting quality cannot be ensured. In contrast, by using lens 11 having emission surface 112 according to the present exemplary embodiment, lighting device 1 creates light distribution S1 in which the illuminance gradually becomes darker from the central portion to the outer edge, and this suppresses a sharp decrease in illuminance to become darker at the outer edge in the light distribution of lighting device 1. Accordingly, the lighting device can be downsized, and lighting quality can be ensured even when the lighting device is disposed near a lighting target surface.

### Second Exemplary Embodiment

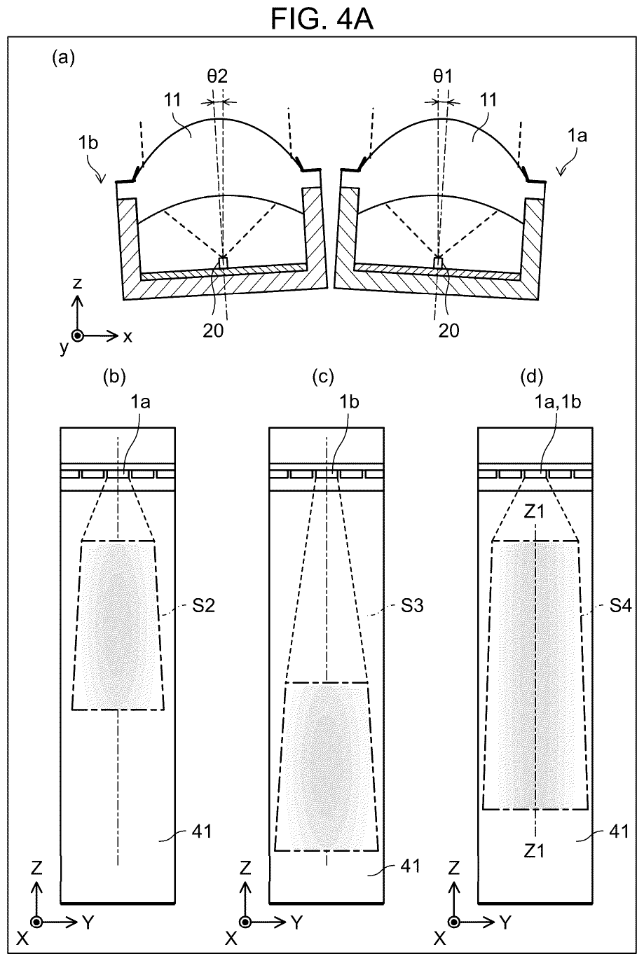

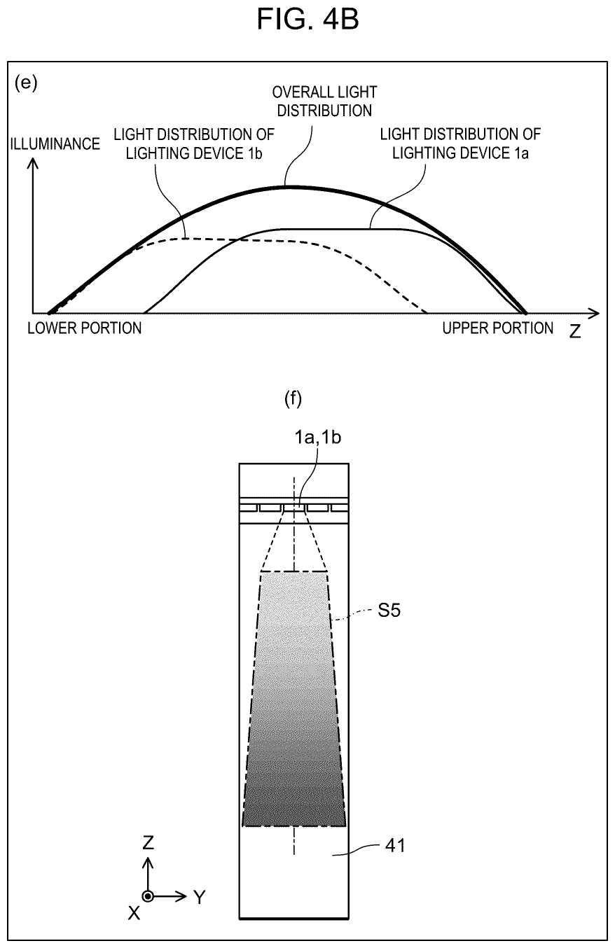

FIG. 4 is a view for explaining a lighting device according to a second exemplary embodiment. Specifically, part (a) of FIG. 4A is a side cross-sectional view of lighting devices 1a and 1b, part (b) of FIG. 4A is a front view illustrating the light distribution of lighting device 1a, part (c) of FIG. 4A is a front view illustrating the light distribution of lighting device 1b, part (d) of FIG. 4A is a front view illustrating the light distribution of lighting devices 1a and 1b, and part (e) of FIG. 4B is the illuminance distribution diagram in Z1-Z1 cross section in part (d) in FIG. 4. Note that each of lighting devices 1a and 1b has the same configuration as lighting device 1 and includes LED light source 20 of the same color.

As illustrated in part (a) of FIG. 4A, in the second exemplary embodiment, two lighting devices 1 (1a, 1b) are arranged in the x direction. In lighting devices 1a and 1b, LED light sources 20 that emit light at predetermined angles θ1 and 02 with respect to the optical axis direction of lenses 11 are disposed. With the arrangement of LED light sources 20, lighting devices 1a and 1b create light distribution S2 for lighting the upper part of lighting target surface 42 and light distribution S3 for lighting the lower part of lighting target surface 42 (see parts (b) and (c) of FIG. 4A). When lighting devices 1a and 1b are arranged in the x direction as illustrated in part (a) of FIG. 4A, the lower end portion of light distribution S2 of lighting device 1a and the upper end portion of light distribution S3 of lighting device 1b overlap each other, and lighting devices 1a and 1b create light distribution S4 as illustrated in part (d) of FIG. 4A. Thus, as illustrated in part (e) of FIG. 4B, light distribution S4 (overall light distribution) of lighting devices 1a and 1b has no unevenness in illuminance, and uniform lighting can be created.

When LED light sources 20 of different colors are arranged in lighting devices 1a and 1b, lighting devices 1a and 1b create light distribution S5 as illustrated in part (f) of FIG. 4B. As described above, since the lower end portion of light distribution S2 of lighting device 1a and the upper end portion of light distribution S3 of lighting device 1b overlap each other, light distribution S5 of lighting devices 1a and 1b has a gradation in which the color gradually changes from the upper portion to the lower portion. For example, when lighting device 1a has LED light source 20 of red and lighting device 1b has LED light source 20 of blue, light distribution S5 of lighting devices 1a and 1b has a gradation from the top to the bottom in which the color gradually changes from red to magenta and then from magenta to blue. That is, gradational expression can be made by disposing lighting devices 1a and 1b having LED light sources 20 of different colors.

In the present exemplary embodiment, the case where two lighting devices 1 (1a, 1b) are arranged has been exemplary described, but three or more lighting devices 1 may be arranged.

In the present exemplary embodiment, a plurality of lighting devices 1 (1a, 1b) are arranged in the x direction, but the arrangement of lighting devices 1 is not limited thereto. A similar effect can be obtained by at least overlapping the light distributions of a plurality of lighting devices 1 in a range along the up-down direction.

### Third Exemplary Embodiment

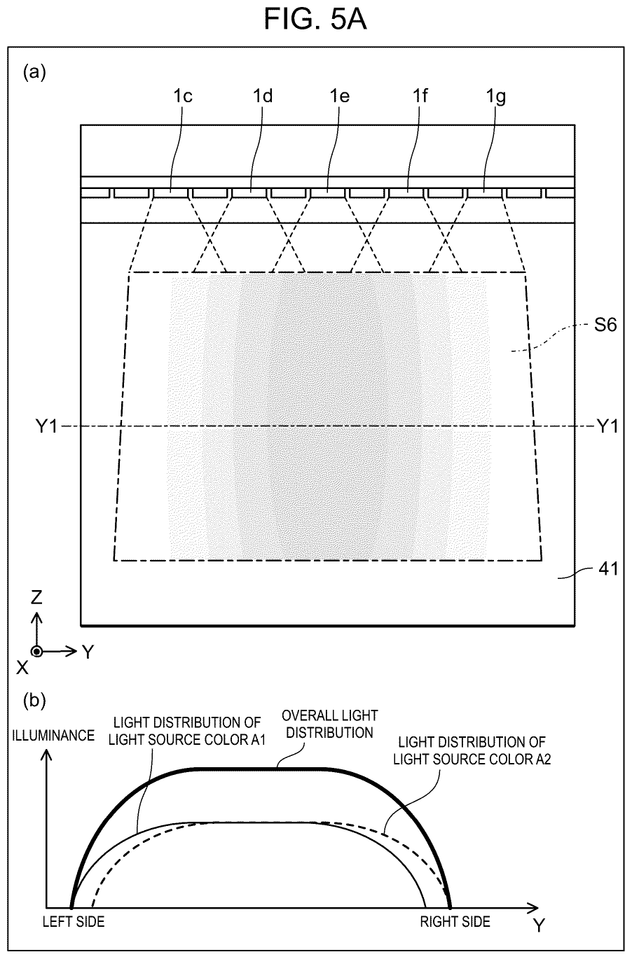

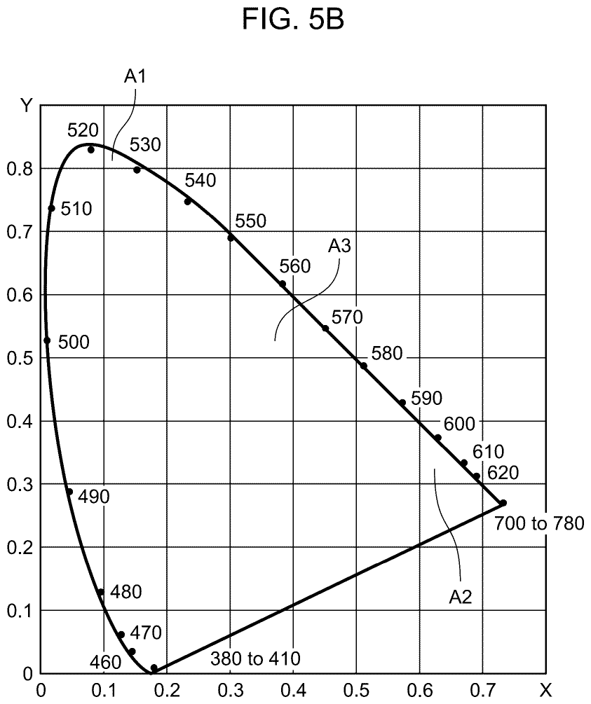

FIG. 5 is a view for explaining a lighting device according to a third exemplary embodiment. Specifically, part (a) of FIG. 5A is a front view illustrating the light distribution of lighting devices 1c to 1g, part (b) of FIG. 5A is the illuminance distribution diagram in Y1-Y1 cross section in part (a) of FIG. 5A, and FIG. 5B is an XY chromaticity diagram. Note that lighting devices 1c to 1g have the same configuration as lighting device 1.

As illustrated in part (a) of FIG. 5A, in the third exemplary embodiment, lighting devices 1c to 1g are arranged in the Y direction at a predetermined interval on the upper portion of lighting target surface 42. In lighting devices 1c to 1g, LED light sources 20 of different colors are arranged.

As illustrated in part (b) of FIG. 5A, in light distribution S6 (overall light distribution) of lighting devices 1c to 1g, the illuminance is uniform at the central portion and gradually decreases toward left and right ends. This is because the light distributions of adjacent lighting devices 1 (1c to 1g) overlap by their ends in the Y direction, and this eliminates unevenness in illuminance in light distribution S6 of lighting devices 1c to 1g.

Here, a method of setting the color of LED light sources 20 arranged in lighting devices 1c to 1g will be described with reference to FIG. 5B. The XY chromaticity diagram is a type of color system for expressing color, and a color is expressed as a color mixing ratio by distributions of chromaticity X and chromaticity Y. Therefore, any color can be expressed by appropriately combining the chromaticity X and chromaticity Y. The colors of LED light sources 20 of lighting devices 1c to 1g are set based on the XY chromaticity diagram.

For example, when light distribution S6 of lighting devices 1c to 1g has a gradation that gradually changes from green to red, the color of LED light source 20 of lighting device 1c is set to green (light source color A1, XY chromaticity coordinates (0.1, 0.8)), and the color of LED light source 20 of lighting device 1g is set to red (light source color A2, XY chromaticity coordinates (0.6, 0.3)). The colors of LED light sources 20 of lighting devices 1d to 1f are determined based on the XY chromaticity diagram in accordance with the intervals in the arrangement of lighting devices 1c to 1g. For example, in a case where lighting device 1e is disposed at an intermediate point between lighting devices 1c and 1g, the color of LED light source 20 of lighting device 1e is set to yellow (light source color A3, XY chromaticity coordinates (0.35, 0.55)) which is the color at the intermediate point between light source colors A1 and A2. As described above, by determining the color of LED light source of each lighting device based on the arrangement of the lighting devices and the XY chromaticity diagram, a vivid gradational expression can made by the lighting devices.

In the present exemplary embodiment, the colors of the LED light sources of lighting devices 1c to 1g are different, but the LED light sources of lighting devices 1c to 1g may be of the same color. In this case, light distribution S6 of lighting devices 1c to 1g has illuminance which is uniform in the central portion and gradually decreasing toward the left and right ends, so that light distribution S6 of lighting devices 1c to 1g has no unevenness in illuminance and can create uniform lighting.

In the present exemplary embodiment, the case where five lighting devices 1 (1c to 1g) are arranged has been exemplary described, but two to four or six or more lighting devices 1 may be arranged.

In the present exemplary embodiment, a plurality of lighting devices 1 (1a, 1b) are arranged in the Y direction, but the arrangement of lighting devices 1 is not limited thereto. A similar effect can be obtained by at least overlapping the light distributions of a plurality of lighting devices 1 in a range along the Y direction.

### Fourth Exemplary Embodiment

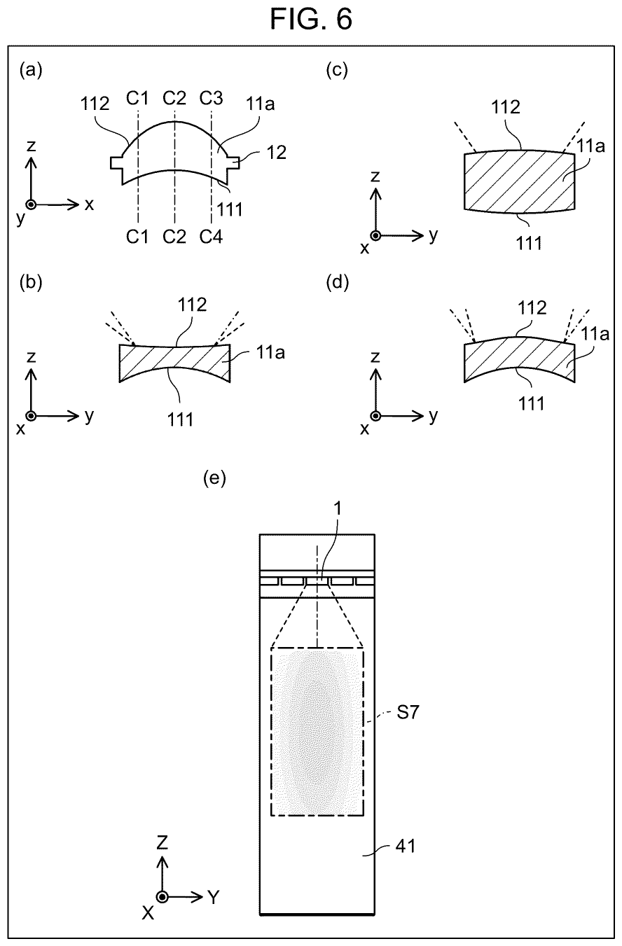

FIG. 6 is a view for explaining a lighting device according to a fourth exemplary embodiment. Specifically, part (a) of FIG. 6 is a side view of lens 11a. Part (b) of FIG. 6 is C1-C1 cross section in part (a) of FIG. 6, and is a cross section of a lens 11a portion to emit light to the upper portion of lighting target surface 42. Emission surface 112 in part (b) of FIG. 6 is an example of a first end, in the x direction, of emission surface 112. Part (c) of FIG. 6 is C2-C2 cross section in part (a) of FIG. 6, and is a cross section of a lens 11a portion to emit light to the central portion, in the up-down direction, of lighting target surface 42. Part (d) of FIG. 6 is C3-C3 cross section in part (a) of FIG. 6, and is a cross section of a lens 11a portion to emit light to the lower portion of lighting target surface 42. Emission surface 112 in part (d) of FIG. 6 is an example of a second end, in the x direction, of emission surface 112. Part (e) of FIG. 6 is a diagram illustrating the light distribution of lighting device 1 in which lens 11a is disposed. In part (e) of FIG. 6, lens 11a is disposed instead of lens 11 in lighting device 1. Lens 11a is formed of the same member as lens 11. In parts (b) and (d) of FIGS. 6, the light emitted from lens 11a in part (c) of FIG. 6 is indicated by one-dot chain lines.

As illustrated in parts (a) to (d) of FIGS. 6, lens 11a has emission surface 112 asymmetric in the x direction. Specifically, lens 11a has emission surface 112 that has a small curvature at a portion emitting light to the upper portion of lighting target surface 42 (see part (b) of FIG. 6) and a large curvature at a portion emitting light to the lower portion of lighting target surface 42 (see part (d) of FIG. 6). That is, as illustrated in FIG. 6, emission surface 112 in part (b) of FIG. 6 has a negative curvature along the y direction, and emission surface 112 in part (d) of FIG. 6 has a positive curvature along the y direction. Therefore, the light emitted from emission surface 112 corresponding to the upper portion of lighting target surface 42 is diffused more widely in the Y direction (y direction) than the light emitted from emission surface 112 corresponding to the lower portion of lighting target surface 42.

In the above description, the relationship of curvature between the first end and the second end in the x direction has been described. The same curvature relationship may be given between a third end and a fourth end (not illustrated) of emission surface 112 in the y direction. Furthermore, emission surface 112 may have the first end and the second end in the x direction and the third end and the fourth end in the y direction, and the curvatures of the first to fourth ends may satisfy the above relationship. Accordingly, light can be widely diffused as described above.

Note that emission surface 112 in part (b) of FIG. 6 does not necessarily have a negative curvature, and emission surface 112 in part (d) of FIG. 6 does not necessarily have a positive curvature. Required is that emission surface 112 in part (b) of FIG. 6 and emission surface 112 in part (d) of FIG. 6 have different curvatures. That is, emission surface 112 in part (b) of FIG. 6 and emission surface 112 in part (d) of FIG. 6 may both have positive curvatures or negative curvatures. In the present application, that emission surface 112 in part (b) of FIG. 6 and emission surface 112 in part (d) of FIG. 6 have different curvatures includes emission surface 112 in part (b) of FIG. 6 and emission surface 112 in part (d) of FIG. 6 having curvatures of the same absolute value but different polarities. Even with the above configuration, an effect of widely diffusing a light can be obtained. The same applies to the curvatures of the third end and the fourth end.

In each of FIGS. 1 to 5, the light distribution of lighting device 1 has a substantially trapezoidal shape having a narrow upper portion and a wide lower portion. This is because the light emitted from lighting device 1 spreads in the X direction and the Y direction as the light travels far from lighting device 1.

In contrast, lighting device 1 in FIG. 6 has lens 11a and thus has substantially rectangular light distribution S7 (see part (e) of FIG. 6) in which light diffusion is wide in the Y direction in the upper portion of lighting target surface 42 and light diffusion is narrow in the Y direction in the lower portion of lighting target surface 42. Since the created light distribution is symmetric in the up-down direction, which is a natural light distribution, a lighting setup with no unpleasant impression can be made. In addition, uniform lighting makes unevenness in illuminance and color less noticeable.

### Fifth Exemplary Embodiment

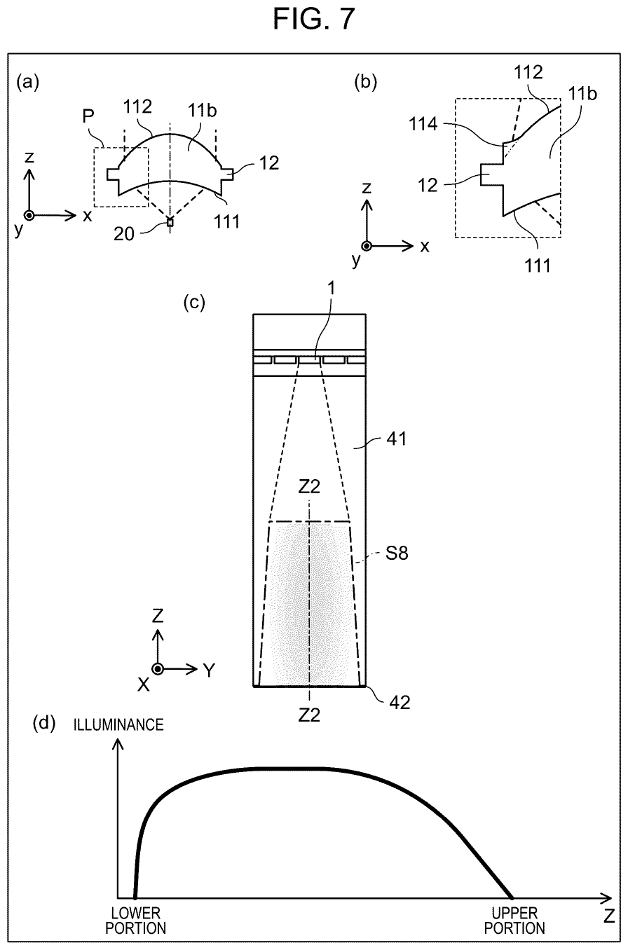

FIG. 7 is a view for explaining a lighting device according to a fifth exemplary embodiment. Specifically, part (a) of FIG. 7 is a side cross-sectional view of lighting device 1, part (b) of FIG. 7 is an enlarged view of region P of lens 11b in part (a) of FIG. 7, part (c) of FIG. 7 is a view illustrating the light distribution of lighting device 1 in which lens 11b is disposed, and part (d) of FIG. 7 illustrates an illuminance distribution diagram in cross section Z2-Z2. In part (c) of FIG. 7, lens 11b is disposed instead of lens 11 in lighting device 1. Lens 11b is formed of the same member as lens 11.

As illustrated in parts (a) and (b) of FIGS. 7, lens 11b has a cutline 114 formed in emission surface 112 on the left side in the drawing. Cutline 114 is provided at the left end in the drawing (the region emitting light to the lower portion of lighting target surface 42) of emission surface 112 to reduce curvature. That is, the left end of emission surface 112 in the drawing is substantially flat. Therefore, lighting device 1 has light distribution S8 in which illuminance sharply decreases at the lower end of lighting target surface 42 (see parts (c) and (d) of FIG. 7).

When lighting device 1 is disposed above lighting target surface 42 and has a light distribution wide in the Z direction (z direction), light distribution S8 of lighting device 1 may not fit within lighting target surface 42 and may reach floor surface 41. In this case, the light emitted from lighting device 1 may be reflected by floor surface 41 to create stray light.

In contrast, the lighting device according to the fifth exemplary embodiment uses lens 11b to create a light distribution in which illuminance sharply decreases at the lower end of lighting target surface 42. This prevents floor surface 41 lighted by the light emitted from lighting device 1.

### Sixth Exemplary Embodiment

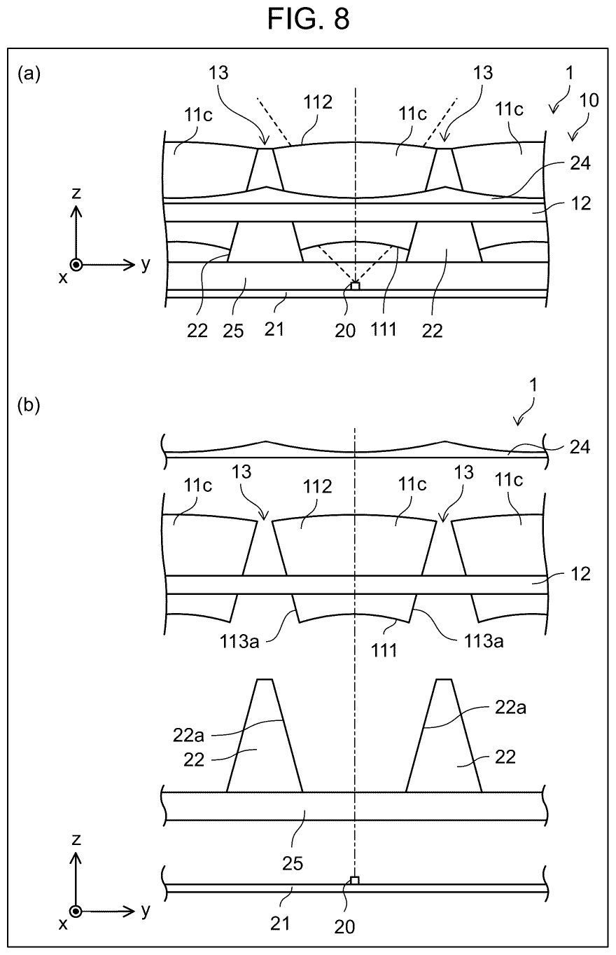

FIG. 8 is a view for explaining a lighting device according to a sixth exemplary embodiment. Specifically, part (a) of FIG. 8 is a front view of lighting device 1, and part (b) of FIG. 8 is an exploded front view of lighting device 1. As compared with FIG. 1, lens 11c is disposed instead of lens 11 in lighting device 1 in FIG. 8. Furthermore, in lighting device 1 in FIG. 8, a plurality of light shielding plates 22 are connected by holder 25.

As illustrated in parts (a) and (b) of FIGS. 8, lens 11c has tapered surfaces 113a inclined with respect to the z direction on two side surfaces in the y direction. On two side surfaces, in the y direction, of light shielding plate 22, tapered surfaces 22a inclined with respect to the z direction are formed. Tapered surfaces 113a and 22a are inclined at the same angle with respect to the z direction. Therefore, when light shielding plate 22 is inserted into the corresponding one of slits 13, light shielding plate 22 makes close contact with no air layer with the help of an adhesive or the like.

As described above, a plurality of light shielding plates 22 are connected to holder 25. That is, a plurality of light shielding plates 22 are integrated by holder 25. Therefore, lens unit 10 and LED light sources 20 can be positioned by assembling light shielding plates 22 and holder 25 in housing 30, so that the accuracy of positioning lens unit 10 and LED light sources 20 can be raised. In addition, since a process of assembling each one of light shielding plates 22 in the corresponding one of slits 13 is not necessary, the lighting device is easier to be assembled.

### Seventh Exemplary Embodiment

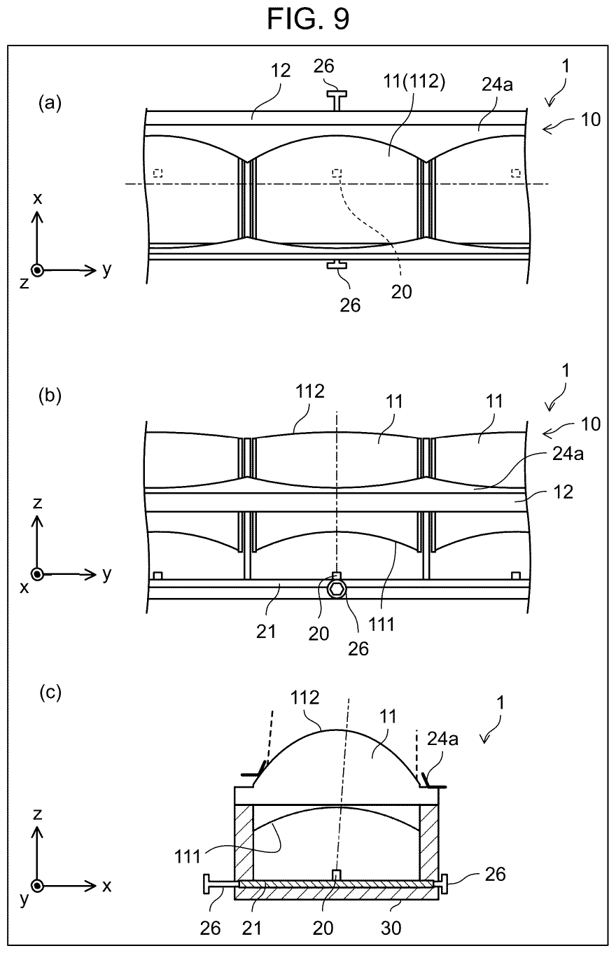

FIG. 9 is a configuration diagram of a lighting device according to a seventh exemplary embodiment. Specifically, part (a) of FIG. 9 is a top view of lighting device 1, part (b) of FIG. 9 is a front view of lighting device 1, and part (c) of FIG. 9 is a side view of lighting device 1. As illustrated in FIG. 9, lighting device 1 includes a moving mechanism 26 (first moving mechanism).

As illustrated in parts (a) to (c) of FIGS. 9, lighting device 1 includes moving mechanism 26. Moving mechanism 26 includes a screw or the like. The position of LED light source 20 in the x direction can be varied by screwing or unscrewing the screw. That is, since the light emitting direction of LED light source 20 can be shifted by operating moving mechanism 26, the light emission direction of lighting device 1 is variable. For example, in a case where lighting target surface 42 is flat, the light emission direction of lighting device 1 needs not to be varied, but in a case where lighting target surface 42 is curved, the light emission direction of lighting device 1 needs to be varied in accordance with the curvature of lighting target surface 42. When the position of the LED light source is to be adjusted in accordance with the curvature of lighting target surface 42 in the production of lighting device 1, cost will increase and downsizing will be difficult. In contrast, lighting device 1 is free of such problems, since the light emission direction of lighting device 1 can be varied by operating moving mechanism 26.

Furthermore, as illustrated in part (c) of FIG. 9, stray light covers 24a that are movable are disposed at left and right ends of emission surface 112 of lens 11. Unnecessary light that is generated by shifting the position of LED light source 20 can be shielded by movable stray light cover 24. There may be provided a mechanism that makes moving mechanism 26 and movable stray light cover 24a move in conjunction with each other. In this case, when the moving amount of movable stray light cover 24a is determined in advance to correspond to the moving amount of moving mechanism 26 according to the shift amount of the optical axis of LED light source 20, installation of the lighting device can be made easily.

In the present exemplary embodiment, moving mechanism 26 includes a screw (a hexagonal bolt in FIG. 9), but it is not limited thereto. Moving mechanism 26 may be anything that can move the position of LED light source 20. For example, using a hollow set screw (grub screw) or the like for moving mechanism 26 can downsize lighting device 1.

### Eighth Exemplary Embodiment

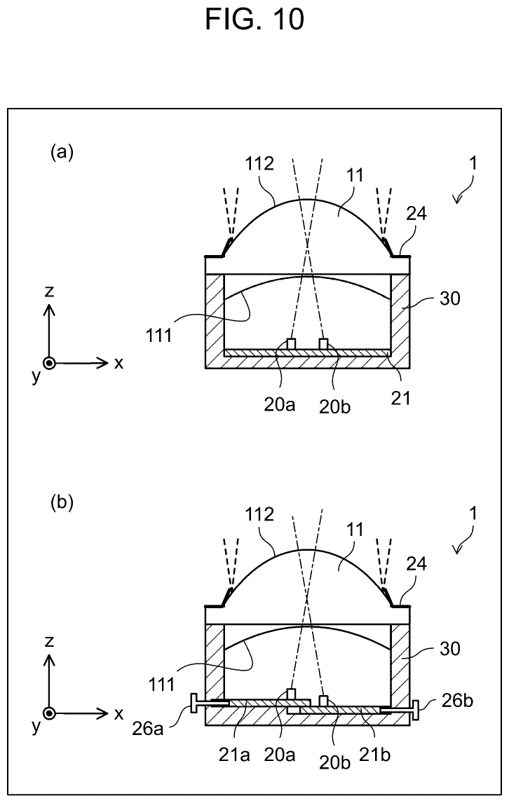

Part (a) of FIG. 10 is a side view of a lighting device according to an eighth exemplary embodiment.

As illustrated in part (a) of FIG. 10, in lighting device 1, a plurality of (here, two) LED light sources 20a and 20b are disposed for one lens 11. In part (a) of FIG. 10, LED light sources 20a and 20b emit light to different regions of lighting target surface 42. In this case, by partially overlapping the light distributions of LED light sources 20a and 20b, the same effects as that in FIGS. 4, 5, and the like can be obtained. For example, in a case where LED light source 20a emits light to the upper portion of lighting target surface 42 and LED light source 20b emits light to the upper portion of lighting target surface 42, the lower portion of the light distribution of LED light source 20a and the upper portion of the light distribution of LED light source 20a overlap, and the same effect as that in FIG. 4 can be obtained. In addition, since a plurality of LED light sources 20 are disposed for one lens 11, the light distribution of the lighting device can be widened and thus the lighting device can be downsized.

Part (b) of FIG. 10 is a side view illustrating another example of the lighting device according to the eighth exemplary embodiment.

As illustrated in part (b) of FIG. 10, LED light sources 20a and 20b are disposed on LED substrates 21a and 21b, respectively, in lighting device 1. Lighting device 1 is provided with moving mechanisms 26a and 26b (second moving mechanism) respectively for moving LED light sources 20a and 20b in the x direction. This enables varying the positions of LED light sources 20a and 20b, and an effect similar to that in FIG. 9 can be obtained.

### INDUSTRIAL APPLICABILITY

The lighting device of the present disclosure is applicable to a lighting setup in a limited narrow space such as indoors, in a train, in a car, or in an airplane, and can be downsized and disposed close to a lighting target surface.

### REFERENCE MARKS IN THE DRAWINGS

1, 1a to 1g: lighting device
10: lens unit
11, 11a to 11c: lens
111: incident surface
111a: convex portion
112: emission surface
114: cutline
20, 20a, 20b: LED light source
21, 21a, 21b: LED substrate
22: light shielding plate
23: absorption layer
24, 24a: stray light cover
25: holder
26: moving mechanism (first moving mechanism)
26a, 26b: moving mechanism (second moving mechanism)
41: floor surface
42: lighting target surface
S1 to S8: light distribution

1. A lighting device that emits light to a lighting target surface, the lighting device comprising:
a light source; and
a lens including an incident surface that receives light emitted from the light source and an emission surface that emits the light received by the incident surface, wherein
the emission surface is a convex curved surface, and
a curvature of the emission surface along a first direction perpendicular to an optical axis direction of the lens is smaller than a curvature of the emission surface along a second direction perpendicular to the optical axis direction and the first direction.

2. The lighting device according to claim 1, wherein the incident surface is a concave curved surface.

3. The lighting device according to claim 2, wherein the incident surface has a convex portion at a central portion of the incident surface.

4. The lighting device according to claim 1, wherein
the emission surface has a first end and a second end in the second direction,
the first end has a first curvature along the first direction, and
the second end has a second curvature along the first direction and different from the first curvature.

5. The lighting device according to claim 4, wherein
the first curvature is a negative curvature, and
the second curvature is a positive curvature.

6. The lighting device according to claim 4, wherein
the emission surface further includes a third end and a fourth end in the first direction,
the third end has a third curvature along the second direction, and
the fourth end has a fourth curvature along the second direction and different from the third curvature.

7. The lighting device according to claim 6, wherein
the third curvature is a negative curvature, and
the fourth curvature is a positive curvature.

8. The lighting device according to claim 1, wherein
the emission surface has a third end and a fourth end in the first direction,
the third end has a third curvature along the second direction, and
the fourth end has a fourth curvature along the second direction and different from the third curvature.

9. The lighting device according to claim 8, wherein
the third curvature is a negative curvature, and
the fourth curvature is a positive curvature.

10. The lighting device according to claim 1, wherein the emission surface includes a cutline provided at one end of the emission surface in the second direction, a curvature being reduced by the cutline.

11. The lighting device according to claim 1, further comprising:
a plurality of the lenses arranged in the first direction;
a light shielding plate disposed in a slit between the plurality of lenses;
an absorption layer that is disposed on each of surfaces, facing the first direction, of the plurality of lenses and absorbs light; and
a stray light cover covering an outer rim of the emission surface.

12. The lighting device according to claim 11, further comprising
a plurality of the light shielding plates; and
a connecting holder that connects the plurality of light shielding plates.

13. The lighting device according to claim 1, further comprising:
a first moving mechanism that varies a position of the light source; and
a stray light cover covering an outer rim of the emission surface, wherein
the stray light cover moves on the emission surface in accordance with a shift of the position of the light source caused by the first moving mechanism.

14. The lighting device according to claim 1, further comprising:
a plurality of the light sources; and
a second moving mechanism that varies a position of each of the plurality of light sources.

15. The lighting device according to claim 1, further comprising
a plurality of the light sources, wherein
the plurality of light sources are arranged with a light distribution of one light source of the plurality of light sources partially overlapping a light distribution of another light source of the plurality of light sources.

16. The lighting device according to claim 15, wherein the plurality of light sources emit pieces of light of different colors.
